(19) United States
(12) Patent Application Publication
(10) Pub. No.: US 2026/0113794 A1
(43) Pub. Date: Apr. 23, 2026

(54) NETWORK DEVICE RECONNECTION AFTER AN OUTAGE

(71) Applicant: Apple Inc., Cupertino, CA (US)

(72) Inventors: Sarvesh Kumar VARATHARAJAN, Milpitas, CA (US); Arun Vijayakumari MAHASENAN, Fremont, CA (US); Venkateswara Rao MANEPALLI, San Jose, CA (US)

(21) Appl. No.: 19/313,853

(22) Filed: Aug. 28, 2025

Related U.S. Application Data
(60) Provisional application No. 63/708,719, filed on Oct. 17, 2024.
(60) Provisional application No. 63/708,732, filed on Oct. 17, 2024.

(51) Int. Cl. H04W 76/15

(52) U.S. Cl. CPC H04W 76/15

(57) ABSTRACT

Network devices that may become disconnected over a network may be reconnected. When a context ID mismatch occurs between the devices, one of the devices may initiate an update request to the other device, causing the other device to update and match the context IDs. In some instances, a device clears the network data and sends a request for the context ID. For example, if the end device detects an address registration failed, the end device optionally removes the address, regenerates a new address, and registers to the parent device. Devices in different partitions over a network may be merged based upon a determination whether a particular device is present or not present in one of the partitions. Also, devices may perform a resynchronization of the security key context to match security keys or frame counts.

### CROSS REFERENCE TO RELATED APPLICATION(S)

The present application claims the benefit of U.S. Provisional Application No. 63/708,719, entitled “NETWORK DEVICE RECONNECTION AFTER AN OUTAGE”, filed Oct. 17, 2024, and U.S. Provisional Application No. 63/708,732 entitled “NETWORK DEVICE RECONNECTION AFTER AN OUTAGE”, filed Oct. 17, 2024, the entirety of which is incorporated herein for reference.

### TECHNICAL FIELD

This application is directed to devices connected to a network via routers, and more particularly, to reconnecting devices after an outage impacting the devices and/or the routers.

### BACKGROUND

Several routers and devices may be connected to each other over a network. When addresses are registered for the routers and the devices, the routers and the devices may communicate with each other. In some instances, one or more routers and/or devices in a network may experience a power outage due to, for example, a loss of power and/or one or more devices and/or routers of the network may otherwise reboot. When power is restored, the routers and/or devices may reboot and update and/or re-register their addresses.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment, in accordance with aspects of the present disclosure.

FIG. 2 illustrates a block diagram of an example system for mesh network communication, in accordance with aspects of the present disclosure.

FIG. 3 illustrates an example of a mesh network and an unattached device in accordance with one or more implementations.

FIG. 4 illustrates an example of a diagram of a network environment with multiple devices connected over networks, in accordance with aspects of the present disclosure.

FIG. 5 illustrates a sequence diagram illustrating example operations that may be performed by a router, in accordance with aspects of the present disclosure.

FIG. 6 illustrates a sequence diagram illustrating example operations that may be performed by an end device, in accordance with aspects of the present disclosure.

FIG. 7 illustrates the network environment, further showing a network with partitions, in accordance with aspects of the present disclosure.

FIG. 8, FIG. 9, FIG. 10, and FIG. 11 illustrate flow diagrams showing an example of a process that may be performed for reconnecting devices over a network, in accordance with implementations of the subject technology.

FIG. 12 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The present disclosure is directed to reconnecting end devices (e.g., network-enabled devices) to routers (e.g., border router, network router) over a network and the address assignment associated therewith. In this detailed description, a device that manages incoming data for another device may be referred to as a “parent device” and a device that depends on another device (e.g., parent device) for data may be referred to as a “child device.” In this regard, a router may be referred to as a parent device, and an end device may be referred to as a child device. Also, when a first router manages incoming data for a second router, the first router and the second router may be referred to as a parent device and a child device, respectively.

In some example situations, parent devices may reboot, such as after a power outage, and advertise and/or register a new address and/or prefix with one or more child devices. However, if when the parent devices advertise different addresses (e.g., prefixes, context IDs) and subsequently converge on a new address, the child device is in a sleepy (e.g., inactive) state and undergoes a prolonged outage, the child device may not register the new address (e.g., a new context ID and/or prefix). When the child device awakens from the inactive state, based on a mismatch of addresses (e.g., prefixes) between the child device and the parent device, data (e.g., communication, updates, etc.) may not be exchanged with the parent device. In one or more implementations, the parent device may send an update request to the child device, subsequent to the child transitioning to an active state, to force an update of the address of the child device so as to match the prefix used by the parent device. The update request may force the registration of a new address by the child device. Alternatively, in one or more implementations, the child device may clear its existing network data (e.g., previously registered prefix and context identifier (ID)), which initiates a registration of a new address (in coordination with the parent device) for the child device.

In one or more implementations, a parent device and a child device (or neighboring device) may be connected over a network as part of a first partition. When the parent device and child device are connected by a relatively weak connection, the child device may subsequently leave, or be removed from, the network and form its own second partition. The parent device may transmit advertisements to the child device to rejoin the first partition and merge the partitions. In order to merge the partitions, a pre-configured set of rules may be followed by the devices of the partitions. However, an additional rule may be implemented that is prioritized over the pre-configured set of rules to force mergers of particular partitions. For example, if the second partition does not include a parent device such as a border router, the partitions may merge (e.g., automatically merge) irrespective of the pre-configured set of rules.

In one or more implementations, the parent device and the child device may experience a mismatch in key sequence counters (or other security data) and/or frame counters, causing data packets to be dropped. For example, a key sequence counter may be established based on a network-wide key. The key sequence counter may increment each time the security key rotates. If, for example, the child device determines that data packets are being dropped for a threshold, or specified, number of times (which may indicate a security key mismatch), the child device may perform a recovery procedure to synchronize the security context between the parent device and the child device. This may include transmitting a message that causes the key sequence counters to synchronize between the devices and to increment, which may include causing the security key to roll forward on all devices on the network. As a result, the respective security keys will match and the encoded data packets may be decoded and read.

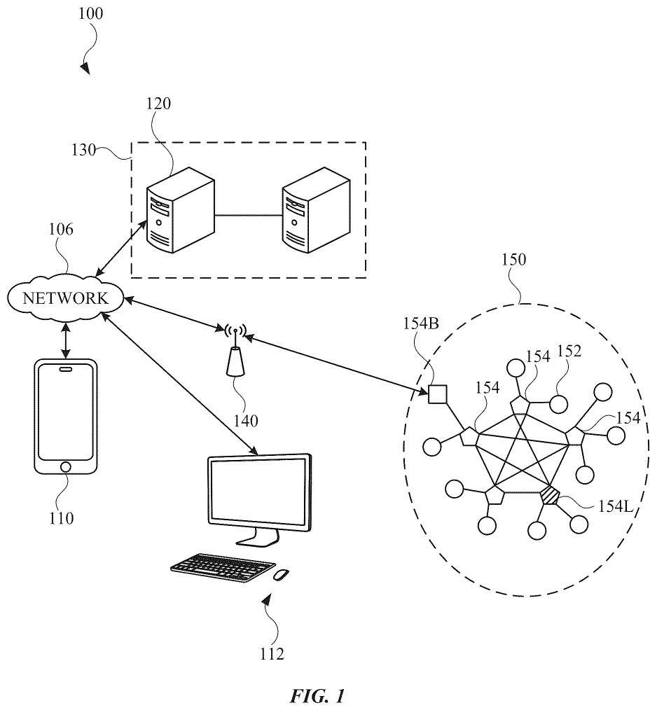

These and other embodiments are discussed below with reference to FIG. 1-12. However, those skilled in the art will readily appreciate that the detailed description given herein with respect to these Figures is for explanatory purposes only and should not be construed as limiting.

FIG. 1 illustrates an example network environment 100 in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The following description is provided for the network environment 100, which may operate in conjunction with the IEEE 802.15.4 standards for low-rate wireless personal area networks (LR-WPANs). It is understood that the concepts disclosed herein may also be applied to other networks, including Thread®, Zigbee®, Z-Wave®, Bluetooth Low Energy (BLE), ISA100.11a, WirelessHART®, MiWi™, IPv6 over Low-Power Wireless Personal Area Networks (6LoWPAN), Subnetwork Access Protocol (SNAP), Wi-Fi mesh networks, and the like.

In the example of FIG. 1, the network environment 100 includes an electronic device 110, an electronic device 112, a server 120, an access point 140 and a mesh network 150. The network 106 may communicatively (directly or indirectly) couple the electronic device 110 and/or the server 120. In one or more implementations, the network 106 may be an interconnected network of devices that may include, or may be communicatively coupled to, the Internet. For explanatory purposes, the network environment 100 is illustrated in FIG. 1 as including the electronic device 110, the electronic device 112, and the server 120; however, the network environment 100 may include any number of electronic devices and any number of servers or a data center including multiple servers.

The electronic device 110 may be, for example, a desktop computer, a portable computing device such as a laptop computer, a smartphone, a peripheral device (e.g., a digital camera, headphones), a tablet device, a router, a wearable device such as a watch, a band, and the like. In FIG. 1, by way of example, the electronic device 110 is depicted as a mobile electronic device (e.g., smartphone).

The electronic device 112 may be, for example, desktop computer, a portable computing device such as a laptop computer, a smartphone, a peripheral device (e.g., a digital camera, headphones), a tablet device, a router, a wearable device such as a watch, a band, and the like. In FIG. 1, by way of example, the electronic device 112 is depicted as a desktop computer.

The server 120 may form all or part of a network of computers or a group of servers 130, such as in a cloud computing or data center implementation. For example, the server 120 stores data and software, and includes specific hardware (e.g., processors, graphics processors and other specialized or custom processors) for rendering and generating content such as graphics, images, video, audio and multi-media files. In an implementation, the server 120 may function as a cloud storage server that stores any of the aforementioned content generated by the above-discussed devices and/or the server 120.

In the example of FIG. 1, the electronic device 110 is depicted as a smartphone. However, it is appreciated that the electronic device 110 may be implemented as another type of device, such as a wearable device (e.g., a smart watch or other wearable device). The electronic device 110 may be a device of a user (e.g., the electronic device 110 may be associated with and/or logged into a user account for the user at a server). Although the electronic device 110 is shown in FIG. 1 as a single electronic device, it is appreciated that the network environment 100 may include more than one electronic device, including more than one electronic device of a user and/or one or more other electronic devices of one or more other users. Although the electronic device 110 and the electronic device 112 are depicted as being outside the mesh network 150, in various use cases, and/or at various times, the electronic device 110 and/or the electronic device 112 may be included in the mesh network 150.

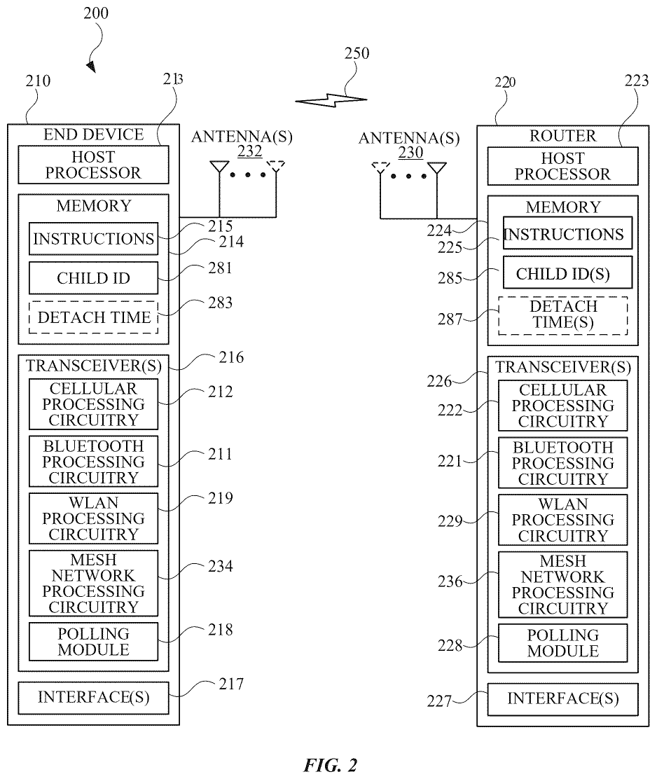

In the example of FIG. 1, the mesh network 150 includes various end devices (e.g., end device 152) and one or more routers 154 (each of which may include any one of the electronic devices 110 or 112, and/or other electronic devices). In one or more implementations, the one or more routers 154 (represented as pentagons in the figure) may forward packets (e.g., data) between and/or to the end devices 152 (represented as circles in the figure) of the mesh network 150. In some use cases, a router of the one or more routers 154 may transmit a packet via a radio or transceiver, such as the one or more transceivers 226 of FIG. 2, to a targeted end device 152 via another router of the one or more routers 154. The one or more routers 154 may also provide secure commissioning services for other devices attempting to join the mesh network 150. The one or more transceivers 226 of each router of the one or more routers 154 may be enabled at times for a specified duration to receive and transmit packets.

In one or more implementations, the end devices 152 and the routers 154 may communicate according to a mesh network communication protocol (e.g., a THREAD® network protocol) for the mesh network 150. For example, the mesh network communication protocol may govern how a device acting as a router of the one or more routers 154 forwards packets between end devices 152 of the mesh network 150. In one or more implementations, each device acting as a router of the one or more routers 154 may act as a parent device for one or more of the end devices 152. The parent device may provide connectivity for, and manage communication with, the end devices that are child devices of that parent device. As such, an end device 152 may utilize a radio thereof to transmit a message to another end device, e.g., over the mesh network 150, via at least its parent router of the one or more routers 154. As shown in FIG. 1, a mesh network, such as mesh network 150, may include multiple devices acting as routers 154. Devices that may act as routers of the one or more routers 154 in the mesh network 150 may include devices that are specifically implemented (e.g., in hardware) as routers, and/or router-eligible end devices that can act as end devices and can perform router operations for other end devices.

Each end device 152 of the mesh network 150 may communicate primarily with a router (e.g., a single router) of the one or more routers 154, which may be referred to as a parent (or parent device) of the end device 152. For example, the end devices 152 may not forward packets for other network devices (e.g., end devices such as the end 152 and a router of the one or more routers 154).

In various implementations and/or use cases, the roles of various devices in the mesh network 150 may be dynamic. For example, if a router of the one or more routers 154 does not have any child devices (e.g., end devices, such as the end device 152, that are communicatively coupled), the router may be downgraded and/or configured to operate as an end device 152. In another example, if a new end device (e.g., similar to the end device 152) attempting to join the mesh network 150 is within range of a current end device (e.g., end device 152) of the mesh network 150 (but not a router 154), and that end device 152 is eligible to become a router 154 (e.g., is a router-eligible end device (REED)), that end device may be upgraded and/or configured to operate as a router for the new end device. In that case, the new router acts as a router (e.g., a router of the one or more routers 154) with respect to the new end device and may be communicatively coupled to one or more other routers of the mesh network 150.

In one or more implementations, a router (e.g., including the leader 154L) of the one or more routers 154 may act as a parent device for an end device 152 that is a sleepy end device (SED), such as by buffering incoming data while the SED is in a sleep state. This procedure involves a downlink message to the SED, where the router of the one or more router 154 buffers the data until the SED awakens and queries for the data, known as the polling procedure. The SED then keeps its receiver (e.g., receiver portion of the one or more transceivers 216 of FIG. 2) active for a specified duration to receive the incoming data.

Examples of device that can operate as end devices 152 include a cellular phone, a smart phone, a session initiation protocol phone, a laptop, a satellite radio, a global positioning system, a multimedia device, a video device, a digital audio player, a personal digital assistant, a camera, a game console, a tablet, a smart device, a wearable device, a vehicle, an electric meter, a gas pump, a kitchen appliance, a healthcare device, an implant, a sensor, an actuator, a display, or any other similar functioning device. Some or all of the end devices 152 may be referred to as Internet-of-Things (IoT) devices. Some or all of the end devices 152 may have the capability of acting as a router of the one or more routers 154, some of the end devices 152 may not have the capability of acting as routers, and/or some of the routers 154 may be specifically implemented (e.g., in hardware) as routers and may not have the capability of acting as an end device. As examples, the routers 154 may be implemented as routers or router-enable end devices (REEDs) that can act as routers or end devices. Examples of REEDs include a cellular phone, a smart phone, a session initiation protocol phone, a laptop, a satellite radio, a global positioning system, a multimedia device, a video device, a digital audio player, a personal digital assistant, a camera, a game console, a tablet, a smart device, a wearable device, a vehicle, an electric meter, a gas pump, a kitchen appliance, a healthcare device, an implant, a sensor, an actuator, a display, or any other similar functioning device with the capability (e.g., hardware and software capabilities) of acting as a router (e.g., forwarding packets for other devices).

In one or more implementations, a router 154 of the mesh network 150 may perform a leader role for the mesh network 150. For example, the mesh network 150 of FIG. 1 includes a router 154 that serves as a leader 154L (e.g., a leader node) in the mesh network 150. For example, the leader 154L may perform a leader role in the mesh network. In one or more implementations, performing the leader role may include managing the overall network structure and operation of the mesh network 150, including initialization, synchronization, and topological control. Performing the leader role may include aggregating and distributing network-wide confirmation information to the other routers 154 and the end devices 152 of the mesh network 150. Performing the leader role may include determining whether a router-eligible end device (REED) acting as an end device 152 in the mesh network 150 is authorized to upgrade to act as a router 154 in the mesh network 150, and/or determining whether a REED acting as a router 154 in the mesh network 150 is authorized to downgrade to act as an end device 152 in the mesh network 150.

In one or more implementations, a router 154 of the mesh network 150 may forward information between the mesh network and a non-mesh network, such as a Wi-Fi network. For example, the border router 154B may forward information between the mesh network 150 and a non-mesh network, such as the network 106, such as through the access point 140. In that case, the router may be referred to as a border router 154B, and may convert a Wi-Fi message to the mesh network communication protocol and transmit the converted mesh network message to a target end device (e.g., end device 152) for the message using a mesh network radio. For explanatory purposes, only the border router 154B is illustrated as being connected to the access point 140, however, it is appreciated that the mesh network 150 may include more than one border router (e.g., one or more of the other routers 154 may also be configured to act as a border router 154B) connected to the access point 140 in some implementations.

FIG. 2 illustrates a block diagram of an example of a system 200 including an end device and a router of a mesh network in accordance with one or more implementations. The system 200 may be a portion of the network environment 100. The end device 210 may be, for example, one of the end devices 152 of the mesh network 150. The router 220 may be, for example, one of the routers 154 of the mesh network 150. In one or more use cases, the router 220 may be a parent device to the end device 210 (e.g., the end device 210 may be a child device of the router 220).

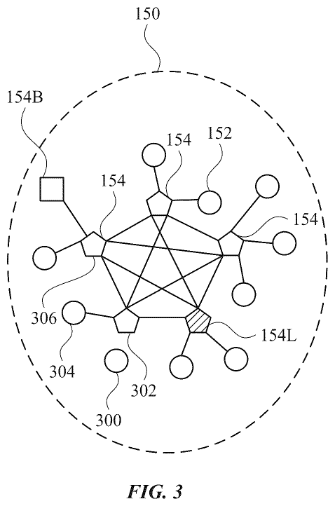

As shown in FIG. 2, the end device 210 may include a host processor 213. The host processor 213 may execute instructions such that various operations of the end device 210 are performed. For example, the host processor 213 can serve as the CPU responsible for executing instructions and managing various tasks, such as one or more of the operations described herein in connection with FIGS. 3-8. The host processor 213 can include multiple cores, each capable of handling multiple threads simultaneously, enabling multitasking. The host processor 213 can integrate various components such as arithmetic logic units (ALUs), registers, cache memory, and control units to execute instructions and process data. Additionally, the host processor 213 can include integrated DSPs, graphics processing units (GPUs), neural processing units (NPUs), and hardware accelerators for enhanced performance in tasks such as multimedia processing, artificial intelligence (AI), and gaming. The host processor 213 may be implemented using, for example, an ASIC, a controller, a FPGA device, another hardware device, a firmware device, or any combination thereof configured to perform the operations described herein.

The end device 210 may include one or more transceivers 216 that may include radio frequency (RF) transmitter and/or receiver circuitry that use one or more antennas 232 of the end device 210 to facilitate communication (e.g., the signaling 250) to and/or from the end device 210 with other devices (e.g., the router 220) according to corresponding wireless communication protocols (e.g., THREAD®, cellular, WI-FI®, BLUETOOTH®). The one or more transceivers 216 can be responsible for both transmitting and receiving radio signals. The one or more transceivers 216 can facilitate wireless communication by converting digital data into radio waves for transmission and then converting received radio waves back into digital data for the end device 210 to process. The one or more transceivers 216 can operate within specific frequency bands allocated for wireless communication and may employ various modulation techniques to optimize data transmission efficiency and reliability. In one or more implementations, the one or more transceivers 216 are not limited to specific wireless communication protocols, including BLUETOOTH®, THREAD®, WI-FI®, cellular, among others, as it is appreciated that other wireless communication protocols and/or technologies can be associated with the one or more transceivers 216.

The end device 210 may include memory 214. The memory 214 may include a non-transitory computer-readable storage medium that stores instructions 215 (which may include, for example, the instructions being executed by one or more components in the one or more transceiver 216s and/or the host processor 213). The instructions 215 may also be referred to as program code or a computer program. The memory 224 may also store data used by, and results computed by, the transceiver 216 and/or the host processor 213. As shown in FIG. 2, the end device 210 may store a child ID 281. For example, the child ID 281 may be an identifier for the end device 210 that has been provided to the end device 210 (e.g., by the router 220) during an attachment procedure for attaching the end device 210 to the mesh network 150. In one or more implementations, the child ID 281 may be stored in persistent memory at the end device 210 so that the end device 210 can use the child ID 281 to attempt to re-attach to the mesh network 150 in the event of a detachment or disconnection of the end device 210 from the mesh network 150. In one or more implementations as discussed in further detail hereinafter, in the event of a detachment or disconnection from the mesh network, the end device 210 may store a detach time 283, which indicates the time at which the end device 210 was detached from the mesh network.

The end device 210 may include cellular processing circuitry 212. The cellular processing circuitry 212 is responsible for handling communication tasks related to the transmission and reception of wireless signals. The cellular processing circuitry 212 is specialized for managing the modulation, demodulation, encoding, decoding, and other signal processing tasks necessary for cellular communication. The cellular processing circuitry 212 can interface with the RF components and antenna(s) (e.g., the one or more antennas 232) to transmit and receive data, voice, and other multimedia content over wireless networks such as Global System for Mobile Communications (GSM), CDMA, LTE, and 5G. The cellular processing circuitry 212 also manages power control, signal quality monitoring, and handover procedures to ensure reliable and efficient communication. The cellular processing circuitry 212 may execute instructions such that various operations of the end device 210 are performed, as described herein. The cellular processing circuitry 212 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The end device 210 may include Bluetooth processing circuitry 211. The Bluetooth processing circuitry 211 is responsible for managing the transmission and reception of wireless signals to and from mobile devices (e.g., end device 210) for Bluetooth communication. The Bluetooth processing circuitry 211 can perform various signal processing tasks related to modulation, demodulation, encoding, decoding, and error correction to ensure reliable communication over the air interface. The Bluetooth processing circuitry 211 may execute instructions such that various operations of the end device 210 are performed, as described herein. The Bluetooth processing circuitry 211 may include one or more baseband processors implemented using, for example, a CPU, a DSP, an ASIC, a controller, an FPGA device, another hardware device, a firmware device, or any combination thereof configured to perform the operations described herein.

The end device 210 may include WLAN processing circuitry 219. The WLAN processing circuitry 219 is responsible for managing the transmission and reception of wireless signals to and from mobile devices (e.g., end device 210) for Wi-Fi communication. The WLAN processing circuitry 219 can perform various signal processing tasks related to modulation, demodulation, encoding, decoding, and error correction to ensure reliable communication over the air interface. The WLAN processing circuitry 219 may execute instructions such that various operations of the end device 210 are performed, as described herein. The WLAN processing circuitry 219 may include one or more baseband processors implemented using, for example, a CPU, a DSP, an ASIC, a controller, an FPGA device, another hardware device, a firmware device, or any combination thereof configured to perform the operations described herein.

The end device 210 may include mesh network processing circuitry 234. The mesh network processing circuitry 234 is responsible for managing the transmission and reception of wireless signals to and from mobile devices (e.g., end device 210) for mesh network communication. The mesh network processing circuitry 234 can perform various signal processing tasks related to modulation, demodulation, encoding, decoding, and error correction to ensure reliable communication over the air interface. The mesh network processing circuitry 234 may execute instructions such that various operations of the end device 210 are performed, as described herein. The mesh network processing circuitry 234 may include one or more baseband processors implemented using, for example, a CPU, a DSP, an ASIC, a controller, an FPGA device, another hardware device, a firmware device, or any combination thereof configured to perform the operations described herein.

In one or more implementations, the one or more transceivers 216 can operate in conjunction with the mesh network processing circuitry 234 to facilitate mesh network communication. The one or more transceivers 216 may be responsible for converting digital data from the mesh network processing circuitry 234 into radio signals for transmission over the air and for receiving incoming radio signals, which are then converted back into digital data for processing by the mesh network processing circuitry 234. This collaboration enables the end device 210 to transmit and receive data, supporting functions such as voice calls, text messaging, Internet access, and other wireless services via the mesh network 150 of FIG. 1. The mesh network processing circuitry 234 manages the digital signal processing tasks, while the one or more transceivers 216 handle the analog RF operations, working together to enable wireless communication capabilities in the end device 210.

The end device 210 and the router 220 may each may include one or more antennas 232 (e.g., one, two, four, or more) and one or more antennas 230 (e.g., one, two, four, or more), respectively. In implementations having the one or more antennas 230, the router 220 may perform multiple-in-multiple-out (MIMO), digital beamforming, analog beamforming, beam steering, etc. For implementations of the one or more antennas 232 having multiple antennas, the end device 210 may leverage the spatial diversity of such multiple antennas to send and/or receive multiple different data streams on the same time and frequency resources.

The end device 210 may include one or more interface(s) 217. The interface(s) 217 may be used to provide input to or output from the end device 210. For example, an end device 210 that is a UE may include interface(s) 217 such as microphones, speakers, a touchscreen, buttons, and the like to allow for input and/or output to the UE by a user of the UE. Other interfaces of such a UE may be made up of made up of transmitters, receivers, and other circuitry (e.g., other than the one or more transceivers 216/one or more antennas 232 already described) that allow for communication between the UE and other devices and may operate according to known protocols (e.g., WI-FI®, BLUETOOTH®, and the like).

The end device 210 may include polling block 218. The polling block 218 may be implemented via hardware, software, or combinations thereof. For example, the polling block 218 may be implemented as a processor, circuit, and/or instructions 215 stored in the memory 214 and executed by the host processor 213 and/or the one or more transceiver 216. In some examples, the polling block 218 may be integrated within the one or more transceivers 216. For example, the polling block 218 may be implemented by a combination of software components (e.g., executed by a DSP or a general processor) and hardware components (e.g., logic gates and circuitry) within the one or more transceivers 216. In other examples, the polling block 218 is a separate component from the one or more transceivers 216.

The router 220 may include a host processor 223. The host processor 223 may execute instructions such that various operations of the router 220 are performed. For example, the host processor 223 can serve as the central processing unit (CPU) responsible for executing instructions and managing various tasks, such as one or more of the operations described herein in connection with FIGS. 3-6. The host processor 223 can include multiple cores, each capable of handling multiple threads simultaneously, enabling multitasking. The host processor 223 can integrate various components such as ALUs, registers, cache memory, and control units to execute instructions and process data. Additionally, the host processor 223 can include integrated DSPs, GPUs, NPUs, and hardware accelerators. The host processor 223 may be implemented using, for example, an ASIC, a controller, a FPGA device, another hardware device, a firmware device, or any combination thereof configured to perform the operations described herein.

The router 220 may include one or more transceivers 226 that may include RF transmitter and/or receiver circuitry that use one or more antennas 230 of the router 220 to facilitate signaling (e.g., the signaling 250) to and/or from the router 220 with other devices (e.g., the end device 210) according to corresponding wireless communication protocols (e.g., cellular, Wi-Fi, Bluetooth). The one or more transceivers 226 can be responsible for both transmitting and receiving radio signals. The one or more transceivers 226 can facilitate wireless communication by converting digital data into radio waves for transmission and then converting received radio waves back into digital data for the router 220 to process. The one or more transceivers 226 can operate within specific frequency bands allocated for wireless communication and may employ various modulation techniques to optimize data transmission efficiency and reliability. In one or more implementations, the one or more transceivers 226 are not limited to specific wireless communication protocols, including Bluetooth, Thread®, Wi-Fi, cellular, among others, as it is appreciated that other wireless communication protocols and/or technologies can be associated with the one or more transceivers 226.

The router 220 may include memory 224. The memory 224 may be a non-transitory computer-readable storage medium that stores instructions 225 (which may include, for example, the instructions being executed by one or more components in the transceiver 226 and/or the host processor 223). The instructions 225 may also be referred to as program code or a computer program. The memory 224 may also store data used by, and results computed by, the one or more transceivers 226 and/or the host processor 223. A shown in FIG. 2, the router 220 may store one or more child IDs 285 of one or more child devices of the router 220 (e.g., including the child ID 281 that is also stored at the end device 210, if the end device 210 is a child device of the router 220). In one or more implementations, the router 220 may store one or more detach times 287, which indicate the time(s) at which one or more respective child devices detached or disconnected from the mesh network 150 (e.g., times at which the router 220 last received a communication from the child device(s)). In one or more implementations, the router 220 may store the one or more child IDs while the child device(s) are attached to the mesh network 150 (e.g., and while the router 220 is the parent of that/those child device(s)), and for a predetermined period of time after a detachment of a child device from the mesh network 150. After the predetermined period of time following the detachment of a child device has passed, the router 220 may delete the one or more child IDs 285 of that child device from its memory. In this way, a period of time is provided during which a child device can detach and re-attach to the mesh network 150 using the stored child ID, without performing a full (e.g., new) attachment procedure.

The router 220 may include cellular processing circuitry 222. The cellular processing circuitry 222 is responsible for managing the transmission and reception of wireless signals to and from mobile devices (e.g., end device 210). The cellular processing circuitry 222 can perform various signal processing tasks related to modulation, demodulation, encoding, decoding, and error correction to ensure reliable communication over the air interface. The cellular processing circuitry 222 may execute instructions such that various operations of the router 220 are performed, as described herein. The cellular processing circuitry 222 may include one or more baseband processors implemented using, for example, a CPU, a DSP, an ASIC, a controller, an FPGA device, another hardware device, a firmware device, or any combination thereof configured to perform the operations described herein.

The router 220 may include Bluetooth processing circuitry 221. The Bluetooth processing circuitry 221 is responsible for managing the transmission and reception of wireless signals to and from mobile devices (e.g., end device 210) for Bluetooth communication. The Bluetooth processing circuitry 221 can perform various signal processing tasks related to modulation, demodulation, encoding, decoding, and error correction to ensure reliable communication over the air interface. The Bluetooth processing circuitry 221 may execute instructions such that various operations of the router 220 are performed, as described herein. The Bluetooth processing circuitry 221 may include one or more processors implemented using, for example, a CPU, a DSP, an ASIC, a controller, an FPGA device, another hardware device, a firmware device, or any combination thereof configured to perform the operations described herein.

The router 220 may include WLAN processing circuitry 229. The WLAN processing circuitry 229 is responsible for managing the transmission and reception of wireless signals to and from mobile devices (e.g., end device 210) for Wi-Fi communication. The WLAN processing circuitry 229 can perform various signal processing tasks related to modulation, demodulation, encoding, decoding, and error correction to ensure reliable communication over the air interface. The WLAN processing circuitry 229 may execute instructions such that various operations of the router 220 are performed, as described herein. The WLAN processing circuitry 229 may include one or more processors implemented using, for example, a CPU, a DSP, an ASIC, a controller, an FPGA device, another hardware device, a firmware device, or any combination thereof configured to perform the operations described herein.

The router 220 may include mesh network processing circuitry 236. The mesh network processing circuitry 236 is responsible for managing the transmission and reception of wireless signals to and from mobile devices (e.g., end device 210) for mesh network communication. The mesh network processing circuitry 236 can perform various signal processing tasks related to modulation, demodulation, encoding, decoding, and error correction to ensure reliable communication over the air interface. The mesh network processing circuitry 236 may execute instructions such that various operations of the router 220 are performed, as described herein. The mesh network processing circuitry 236 may include one or more processors implemented using, for example, a CPU, a DSP, an ASIC, a controller, an FPGA device, another hardware device, a firmware device, or any combination thereof configured to perform the operations described herein.

In one or more implementations, the one or more transceivers 226 can operate in conjunction with the mesh network processing circuitry 236 to facilitate mesh network communication. The one or more transceivers 226 is responsible for converting digital data from the mesh network processing circuitry 236 into radio signals for transmission over the air and for receiving incoming radio signals, which are then converted back into digital data for processing by the mesh network processing circuitry 236. This collaboration enables the router 220 to transmit and receive data, supporting functions such as audio services, Internet access, and other wireless services via the mesh network 150 of FIG. 1. The mesh network processing circuitry 236 manages the digital signal processing tasks, while the one or more transceivers 226 handle the analog RF operations, working together to enable wireless communication capabilities in the router 220.

The router 220 may include one or more antennas 230 (e.g., one, two, four, or more). In implementations of the one or more antennas 230 having multiple antennas, the router 220 may perform multiple-in-multiple-out (MIMO), digital beamforming, analog beamforming, beam steering, etc.

The router 220 may include one or more interface(s) 227. The interface(s) 227 may be used to provide input to or output from the router 220. For example, a router 220 may include interface(s) 227 made up of transmitters, receivers, and other circuitry (e.g., other than the transceivers 226/one or more antennas 230 already described) that enables the router 220 to communicate with other equipment in the mesh network 150, and/or that enables the router 220 to communicate with external networks, computers, databases, and the like for purposes of operations, administration, and maintenance of the router 220 or other equipment operably connected thereto.

The router 220 may include a polling block 228. The polling block 228 may be implemented via hardware, software, or combinations thereof. For example, the polling block 228 may be implemented as a processor, circuit, and/or instructions 225 stored in the memory 224 and executed by one or more components in the one or more transceivers 226. In some examples, the polling block 228 may be integrated within the transceivers 226. For example, the polling block 228 may be implemented by a combination of software components (e.g., executed by a DSP or a general processor) and hardware components (e.g., logic gates and circuitry) within the transceivers 226. In other examples, the polling block 228 is a separate component from the transceivers 226.

In one or more implementations, multiple wireless communication protocols (e.g., mesh network and Bluetooth technologies) may coexist in an electronic device (e.g., electronic devices 110-112 of FIG. 1) with a shared radio that operates at 2.4 gigahertz for both Bluetooth and mesh network technologies. The integrated circuit (IC) chip responsible for modulation and demodulation, the software stack, the hardware stack, and the antennas for transmission and reception may all be shared resources between the Bluetooth and mesh network technologies. In one or more implementations, when the mesh network processing circuitry 234 is active, the Bluetooth processing circuitry 211 may not be active, and vice versa, resulting in time division multiplexing between the Bluetooth and mesh network technologies.

In one or more implementations, a device, such as an end device 152 (e.g., end device 210) may not be connected to, or attached to, the mesh network 150. For example, FIG. 3 illustrates a use case in which a device 300 (e.g., an end device 152, such as the end device 210) is an unattached device that is not connected to the mesh network 150. The device 300 may be a full thread device (FTD), such as a router-eligible end device (REED) or a full end device (FED), or a minimal thread device (MTD), such as a minimal end device (MED), a sleepy end device (SED), a synchronized sleepy end device (SSED), or a Bluetooth end device (BED) in various implementations. The device 300 may have never been connected to (e.g., attached to) the mesh network 150, or may have previously been connected to (e.g., attached to) the mesh network 150 and later disconnected to (e.g., detached from) the mesh network 150.

In order to join (e.g., attach to) the mesh network 150, if the device 300 is a new device to the mesh network 150 (e.g., has never attached, or has been detached for greater than a predetermined period of time), the device 300 may perform a full attach procedure. For example, the full attach procedure may include multicasting, by the device 300, a parent request (e.g., a Mesh Link Establishment (MLE) parent request). The parent request may be received by one or more devices of the mesh network 150, including one or more routers 154 (e.g., a potential parent device 302 and a potential parent device 306 that are near the device 300) and/or one or more end devices 152 (e.g., potential parent device 304) that are capable of upgrading to operate as the one or more routers 154 (e.g., one or more REEDs). The device 300 may receive a parent response (e.g., an MLE parent response) from one or more of the devices of the mesh network 150 (e.g., from a router of the one or more routers 154, such as the potential parent device 302, the potential parent device 306, or the potential parent device 304) that received the parent request. The parent response(s) from each responding device may be unicast to the device 300. Once the parent response(s) have been received, the device 300 may select one of the devices (e.g., a router of the one or more routers 154, such as the potential parent device 302) from which the parent response(s) were received as a parent device, and provide a child ID request (e.g., an MLE child ID request) to that selected parent device. The device 300 may then receive a child ID (e.g., child ID 281 of FIG. 2) from the selected parent device, and may store the received child ID in persistent memory at the device 300 (e.g., in memory 214). In one or more implementations, the selected parent device may also store the child ID in its memory (e.g., memory 224 of FIG. 2). Once the child ID is received, the device 300 may be attached to the mesh network and may (e.g., periodically) exchange information (e.g., link information, security information, channel information, and/or other network information) with the selected parent device to maintain the attachment to the mesh network.

In the event that, after attachment, the device 300 loses its connection with the selected parent device (e.g., and fails to send and/or receive the information for maintaining the attachment to the mesh network), the device 300 may use the stored child ID to attempt to re-attach to (e.g., to request and receive updated network connection and/or security information for re-attaching to the mesh network) the previously selected parent device without performing the full attach procedure (e.g., without requesting and selecting a new parent device, and without requesting and receiving a new child ID).

Sending parent requests, receiving parent responses, and selecting a parent device from among multiple devices of the mesh network 150 that provide parent responses to a parent request can be time consuming. Aspects of the subject disclosure may help to reduce the time for the new device to select and attach to a new parent device.

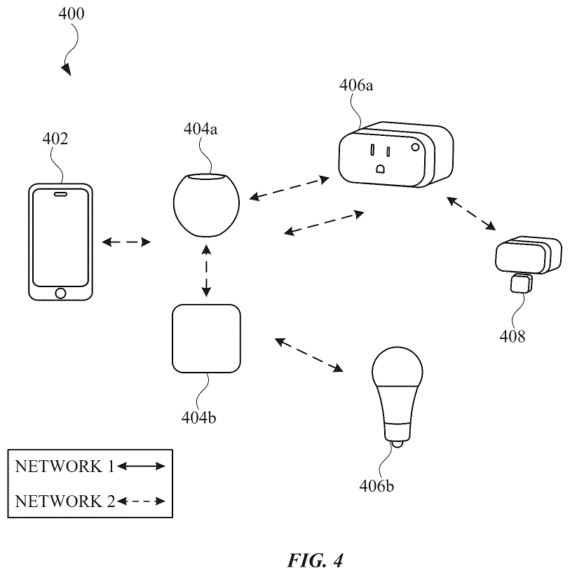

FIG. 4 illustrates an example of a diagram of a network environment 400 with multiple devices connected over networks, in accordance with aspects of the present disclosure. The network environment 400 may include a controller 402, a border router 404a, a border router 404b, a router 406a, a router 406b, and an end device 408. As non-limiting examples, the controller 402 may take the form of a mobile wireless communication device (e.g., smartphone). The border routers 404a and 404b may take the form of a smart speaker, a streaming media player, or a smart home hub. The routers 406a and 406b may take the form of a smart outlet/plug or a smart light bulb, which communicate (e.g., transmit and receive) with other devices. Example of the end device 408 may include a camera, a doorbell, or a door lock, which communicate (e.g., transmit and receive).

As shown, the controller 402 is connected to the border routers 404a and 404b via Network 1 (depicted as a solid line). In one or more implementations, Network 1 is a wireless network (e.g., WI-FI® network). The border routers 404a and 404b may communicate data to and from the controller 402, via Network 1, to the routers 406a and 406b and to the end device 408 via Network 2 (e.g., mesh network, depicted as dotted lines).

Based on the topology, the border routers 404a and 404b may be parent devices relative to the routers 406a and 406b, and to the end device 408. Accordingly, the routers 406a and 406b and the end device 408 may be referred to as child devices. Further, the routers 406a and 406b may be parent devices relative to the end device 408, and the end device 408 may be a child device relative to the routers 406a and 406b. Further, the end device 408 may be referred to as a neighboring device with respect to the router 406a.

In one or more implementations, one or more of the parent devices establish a network connection with one or more child devices over Network 2. For example, the router 406a may advertise a prefix (e.g., off-mode routable (OMR) prefix address) into Network 2 and the end device 408 uses the prefix (e.g., prefix 1) to generate an address and configure its interface with the generated address. The end device 408 may register the address with the router 406a. When the address is registered to the router 406a, the router 406a may not register the full address, but maps the prefix to a context ID (e.g., context ID 1) in a table known to both the router 406a and the end device 408. When the router 406a sees the context ID, the router 406a knows the prefix (due to the mapping) and derives the full address. The router 406a can use the address and determine what data packets are intended for the end device 408, and transmit the data to the end device 408 via the address. In some instances, the end device 408 removes the prefix and stores the context ID along with an interface identifier, which may be randomly, or pseudo-randomly, generated. This address (e.g., context ID and interface identifier) may be accessible outside Network 2 (e.g., by Network 1), thus allowing the controller 402 to communicate data to the end device 408 via Network 1, the border router 404a, the router 406a. The foregoing example may be performed between parent devices and child devices of the network environment 400. Also, in some instances, the end device 408 may be in an inactive state, and unable to transmit or receive data packets. However, based on the prefix and context ID, the router 406a can wait for the end device 408 to transition to an active state to transmit the data packets.

When the prefix advertised by the router 406a is updated or changed, the router 406a and the end device 408 may perform a similar process to establish updated addresses. This may occur when, for example, a power outage (e.g., loss of power) to the routers 406a and 406b occurs followed by a reboot or reset of one or more of the router 406a or the router 406b. Conversely, the end device 408 may not undergo the power outage due to, for example, the end device 408 being battery operated and not dependent upon an external power source. In an example scenario, prior to a power outage that causes the routers 406a and 406b to lose power, the routers 406a and 406b may advertise different prefixes (e.g., prefix 1 and prefix 2), and two prefixes are advertised into Network 2. This may be due to, for example, jitter based on multiple routers on Network 2. The prefixes may be associated with a respective context ID (e.g., prefix 1 and context ID 1, and prefix 2 and context ID 2). According to a protocol of Network 2, the prefixes merge such that only one prefix is advertised. In this regard, one of the two prefixes is removed and marked as stale, and will no longer be advertised over Network 2 after a duration (e.g., five minutes) in order for the end device 408 to still use the prefix to receive data packets. For purposes of illustration, prefix 1 is marked as stale and removed from Network 2 after the duration, while prefix 2 is maintained. However, after the power outage, the router 406a may advertise prefix 2 with context ID 1 (rather than context ID 2).

In some instances, the end device 408 may register prefix 2 and context ID 2 with the end device 408 prior to the power outage. However, the end device 408 may subsequently be inactive while the context ID is updated after the power outage (e.g., by the router 406a) from context ID 2 to context ID 1. In this regard, when the end device 408 transitions to an active state, the end device 408 assumes a prefix/context ID pair of prefix 2, context ID 2. This represents as mismatch of context ID between the router 406a and the end device 408, as the router 406a uses context ID 1 for prefix 2 and there is no longer any context ID 2. Accordingly, the end device 408 may drop data packets from the router 406a and the router 406a may reject communication data from the end device 408. The foregoing example may occur due to a power outage by the border routers 404a and 404b.

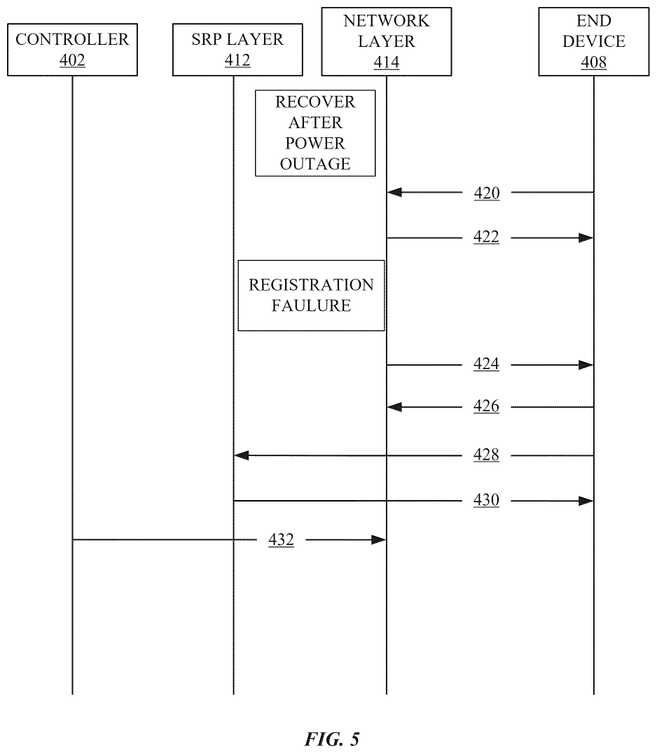

FIG. 5 illustrates a sequence diagram illustrating example operations that may be performed by a router (e.g., router 406a shown in FIG. 4), in accordance with aspects of the present disclosure. The sequence diagram may provide an approach to reconnecting the end device 408 with the router 406a (shown in FIG. 4) over Network 2 (shown in FIG. 4) after the router 406a (representative of the border routers 404a and 404b, and the network layer 414shown in FIG. 4) recovers from a power outage. The service registration protocol (SRP) layer 412 may function as an advertising proxy. The network layer 414 may represent a layer of Network 2 (shown in FIG. 4). In one or more implementations, the SRP layer 412 and the network layer 414 are on the router 406a (shown in FIG. 4).

At operation 420, the end device 408 provides a MLE request to the network layer 414. At operation 422, the network layer 414 provides an MLE response. The operations 420 and 422 may function to provide an OMR registration. However, due to a context ID mismatch (e.g., described in FIG. 4) between the router 406a (shown in FIG. 4) and the end device 408, the OMR registration fails.

In order to perform an OMR address registration, at operation 424, the network layer 414 sends an update request to the end device 408. The update request may force a registration at the end device 408, causing the end device 408 to update its context ID, and accordingly, update its table. As a result, the table (e.g., prefix and context ID) between the network layer 414 and the end device 408 match, and communication of data (e.g., data packets) may resume. At operation 426, the end device 408 may provide an update response, indication the registration is complete.

At operation 428, the end device 408 registers a domain name system (DNS) with the SRP layer 412. At operation 430, the SRP layer 412 provides an acknowledgement to the end device 408. The SRP layer 412 may register the OMR address to an mDNS for advertising over an infrastructure link. The controller 402 may discover the OMR address of the end device 408 via the mDNS. At operation 432, the controller 402 provides an application message to the network layer 414.

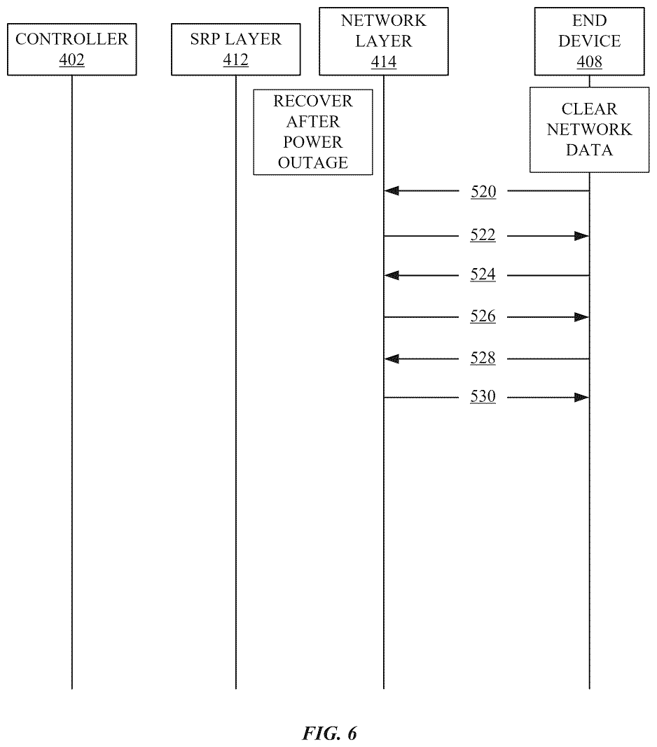

FIG. 6 illustrates a sequence diagram illustrating example operations that may be performed by an end device (e.g., end device 408 shown in FIG. 4), in accordance with aspects of the present disclosure. In this approach, the end device 408 clears its network registration data upon detaching and/or disconnecting from the network, and/or a threshold amount of time after detaching and/or disconnecting from the network. For example, any stored prefix and context ID and/or any corresponding addresses may be removed from memory. As a result, a context ID mismatch between the end device 408 and the router 406a (shown in FIG. 4) may be eliminated.

At operation 520, the end device 408 provides a MLE request to the network layer 414. At operation 522, the network layer 414 provides an MLE response. The operations 520 and 522 may function to provide an OMR registration. At operation 524, the end device 408 provides the network layer 414 with an ID request. Based on the cleared network data, the end device 408 may not currently store a prefix and/or any prefix/context ID associations. At operation 526, the network layer 414 provides an ID request response to the end device 408.

At operation 528, the end device 408 provides an end device update request to the network layer 414. The network layer 414 may update a child address table to include an OMR address registered to the end device 408. At operation 530, the network layer 414 provides an end device update response acknowledgement that includes the OMR address registered to the end device 408. The router 406a (shown in FIG. 4) and the end device 408 may each have the same prefix and context ID association which are reflected in the OMR address registered to the end device 408, and communication of data (e.g., data packets) may resume.

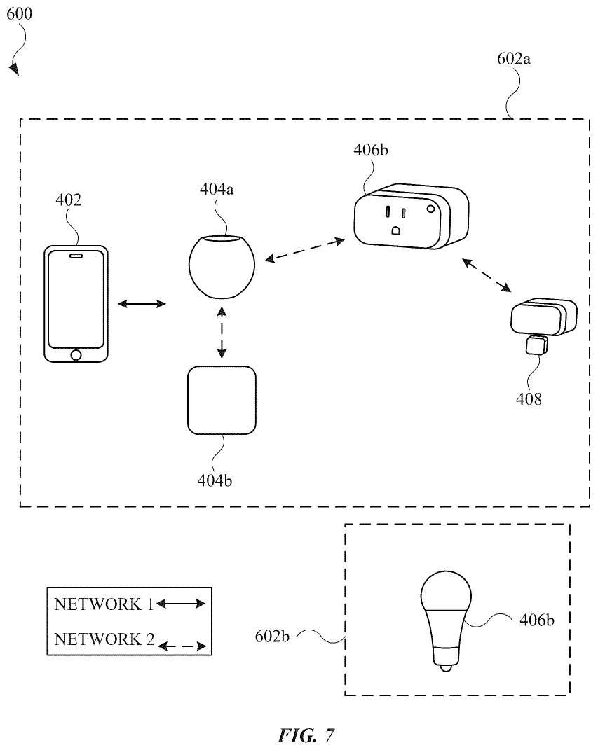

FIG. 7 illustrates the network environment 600, further showing a network with partitions, in accordance with aspects of the present disclosure. The network environment 600 may include a controller 402, a border router 404a, a border router 404b, a router 406a, a router 406b, and an end device 408, each of which is shown and described in FIG. 4.

Devices on the network environment 600 may be grouped according to partitions. For example, a set of devices (e.g., the controller 402, the border routers 404a and 404b, the router 406a, and an end device 408) are part of a partition 602a. Further, the router 406b (representing one or more devices) is part of a partition 602b. Devices in the network environment may be in different partitions for various reasons. For example, a connection or link between the border router 404b and the router 406b may be relatively weak, which may cause the router 406b to miss advertisements from the border router 404b. For example, the received signal strength indicator (RSSI) may be less than a threshold dBm above a noise floor. Further, if the advertisements are missed for a predetermined duration, the router 406b may assume there is no longer a connection with the border router 404b. As a result, the router 406b removes itself from the partition 602a and forms its own partition (e.g., partition 602b).

In one or more implementations, the Network 2 protocol may require the partitions 602a and 602b to merge into a single network or mesh. In this regard, Network 2 may establish and/or may have a preconfigured set of rules for merging the partitions 602a and 602b. For example, one rule may indicate that the partitions (e.g., partitions 602a and 602b) may be weighed according to priority, and the higher priority partition will attempt to merge with a neighboring partition. Another priority-based rule may indicate that a partition be given a low priority when a single router (e.g., leader) is in the partition. Partition IDs may also be assigned to partitions to assign priority.

An additional rule may be implemented, which supersedes the other merging rules. For example, when a partition does not include a border router, the rule may require a forced merger of that partition with another partition. In this regard, the partition 602b includes only the router 406b and does not include a border router (e.g., border routers 404a and 404b). As a result, the router 406b of the partition 602a may force a merger with the devices of the partition 602b. Moreover, this rule may take precedence over other the set of merger rules previously established. Further, this rule (e.g., no border router rule) may be implemented despite the RSSI being less than the threshold dBm above the noise floor.

In one or more implementations, persistent or contiguous security failures may be present in a network environment (e.g., network environment 400 shown in FIG. 4, network environment 600 shown in FIG. 6). A “security failure” may include a failure to decode an encoded data packet using a network wide key that corresponds to a key sequence counter. This may be due to, for example, a mismatched security key or mismatched frame counters between two connected devices. As a result, security issues may cause data packets to be dropped between devices.

In order to overcome this issue, a resynchronization operation may be used. For example, a child device (e.g., end device) may count a number of contiguous failures to use the key to decode data. After the count passes a threshold number of failures, the end device may perform a recovery procedure to synchronize the security context between the child device and a parent device (e.g., router, border router). This may include the child device sending an MLE link request to a neighboring router, or the parent device sending an MLE child update request to a neighboring child to get the updated context and frame counter. By sending the request message by one device, the responding device may roll the key sequence to match the current key or match the current frame count. This may further cause neighboring devices to roll the key sequence to match the current key. As a result, the data packets may be properly decoded.

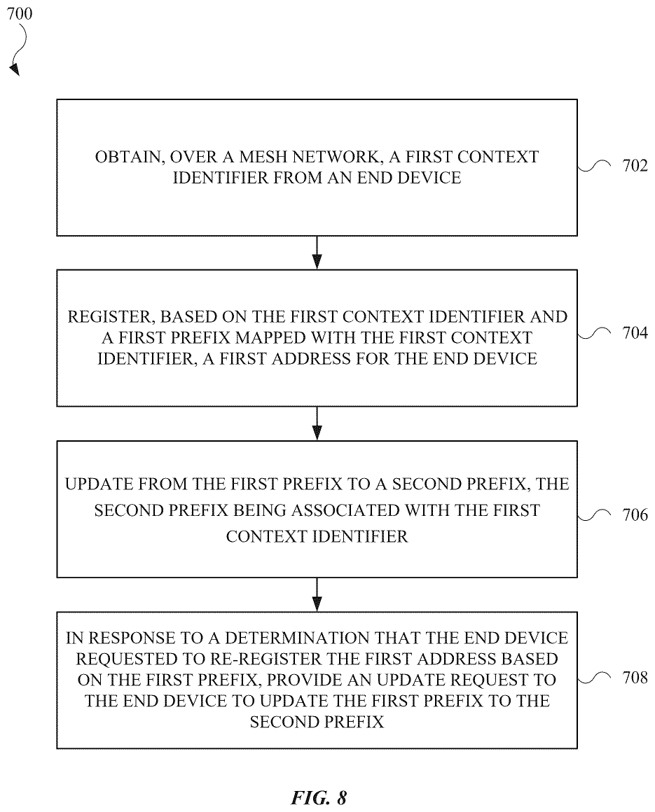

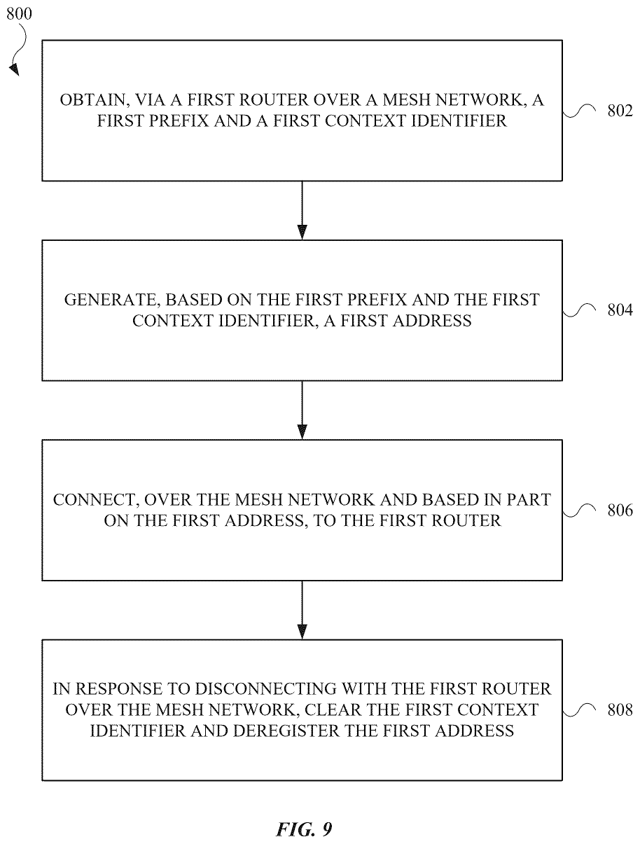

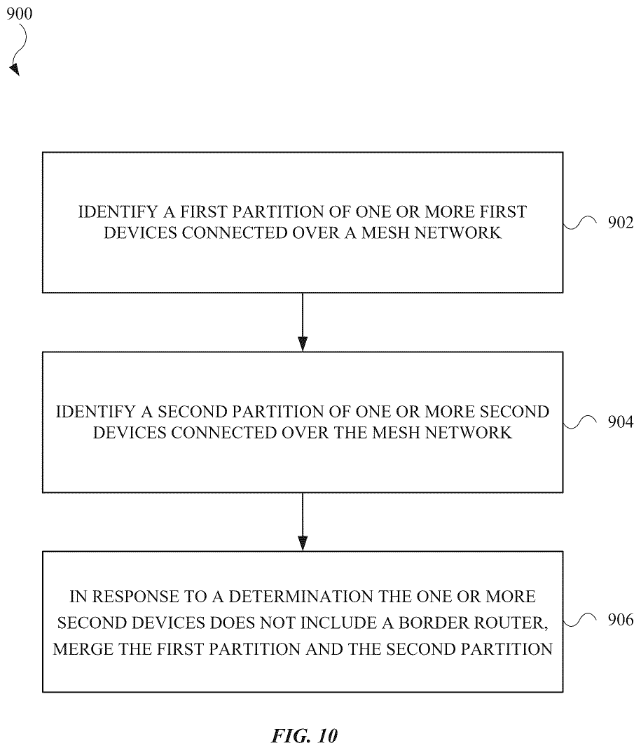

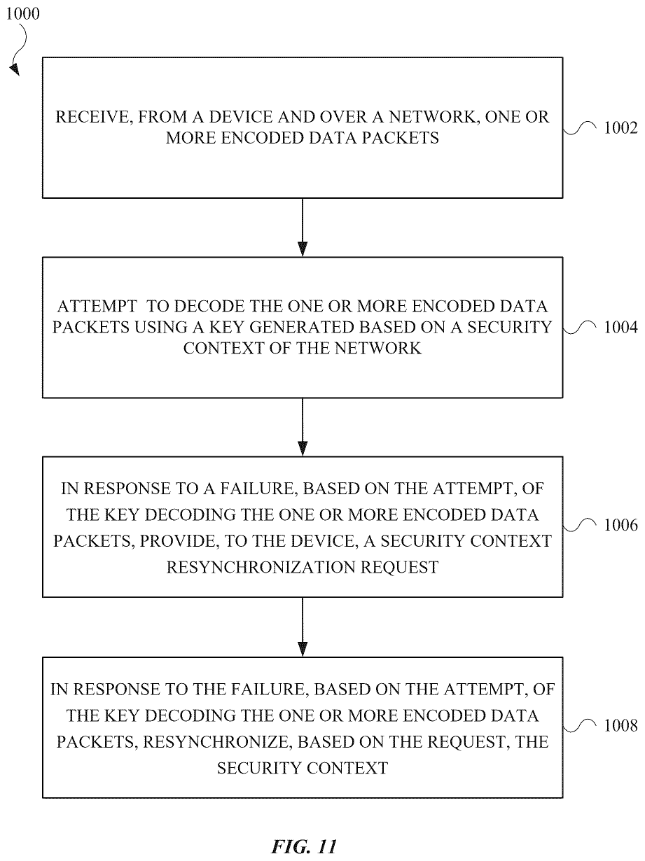

FIG. 8, FIG. 9, FIG. 10, and FIG. 11 illustrate flow diagrams showing an example of a process that may be performed for reconnecting devices over a network, in accordance with implementations of the subject technology. One or more devices, including one or more processors thereof and computer-readable instructions stored thereon, such as routers (e.g., router 406a, border routers 404a and 404b, router 406b shown in FIG. 4) and/or end devices (e.g., end device 408 shown in FIG. 4), may be used in part to conduct one or more steps of the example processes. For explanatory purposes, the respective processes shown in FIGS. 8-11 are primarily described herein with reference to the routers (e.g., router 406a, border routers 404a and 404b, router 406b shown in FIG. 4) and/or end devices (e.g., end device 408 shown in FIG. 4). However, the respective processes shown in FIGS. 8-11 are not limited to the routers (e.g., router 406a, border routers 404a and 404b, router 406b shown in FIG. 4) and/or end devices (e.g., end device 408 shown in FIG. 4), and one or more blocks (or operations) of the respective processes may be performed by one or more other components of other suitable apparatuses, devices, or systems. Further for explanatory purposes, some of the blocks of the respective processes are described herein as occurring in serial, or linearly. However, multiple blocks of the respective processes may occur in parallel. In addition, the blocks of the respective processes need not be performed in the order shown and/or one or more blocks of the respective processes need not be performed and/or can be replaced by other operations.

FIG. 8 illustrates a flow diagram showing an example of a process 700 that may be performed for reconnecting devices over a network, in accordance with aspects of the present disclosure.

At block 702, a first context identifier (e.g., context ID) is obtained from an end device (e.g., end device 408 shown in FIG. 4) over a mesh network (e.g., Network 2 shown in FIG. 4).

At block 704, a first address for the end device is registered based on the first context identifier (e.g., context ID 1) and a first prefix (e.g., prefix 1) mapped with the first context identifier. A router (e.g., router 406a, border routers 404a and 404b, router 406b shown in FIG. 4) may register the first address on itself and on the end device.

At block 706, the first prefix is updated to a second prefix (e.g., prefix 2). The second prefix may be associated with the first context identifier.

At block 708, in response to a determination that the end device requested to re-register the first address based on the first prefix, providing an update request to the end device to update the first prefix to the second prefix.

FIG. 9 illustrates a flow diagram showing an alternate example of a process 800 that may be performed for reconnecting devices over a network, in accordance with aspects of the present disclosure.

At block 802, a first prefix and a first context identifier is obtained via a first router (e.g., border routers 404a and 404b, routers 406a and 406b shown in FIG. 4) over a mesh network (e.g., Network 2 shown in FIG. 4).

At block 804, a first address is generated based on the first prefix and the first context identifier. An end device (e.g., end device 408) may generate the first address.

At block 806, the first router is connected to over the mesh network and based in part on the first address.

At block 808, in response to disconnecting with the first router over the mesh network, the first context identifier is cleared and the first address is deregistered. An end device (e.g., end device 408) clears the first context identifier and the first address is deregistered.

FIG. 10 illustrates a flow diagram showing an example of a process 900 that may be performed for reconnecting devices over a network, in accordance with aspects of the present disclosure.

At block 902, a first partition of one or more first devices connected over a mesh network is identified. The first partition may be identified by a router (e.g., border routers 404a and 404b, routers 406a and 406b shown in FIG. 4).

At block 904, identify a second partition of one or more second devices connected over the mesh network is identified. The second partition may be identified by a router (e.g., border routers 404a and 404b, routers 406a and 406b shown in FIG. 4).

At block 906, in response to a determination the one or more second devices does not include a border router (e.g., border routers 404a and 404b shown in FIG. 4), the first partition and the second partition are merged.

FIG. 11 illustrates a flow diagram showing an example of a process 1000 that may be performed for reconnecting devices over a network, in accordance with aspects of the present disclosure.

At block 1002, one or more encoded data packets are received from a device and over a network.

At block 1004, a decoding of the one or more data packets using a key generated based on a security context of the network is attempted.

At block 1006, in response to a failure, based on the attempt, of the key decoding the one or more encoded data packets, security context resynchronization request provided to the device.

At block 1008, in response to a failure, based on the attempt, of the key decoding the one or more encoded data packets, the security context is resynchronized based on the security context resynchronization request.

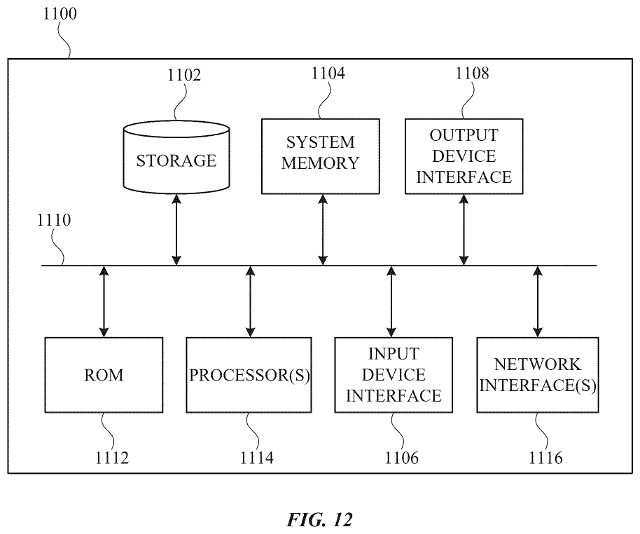

FIG. 12 illustrates an electronic system 1100 with which one or more implementations of the subject technology may be implemented. The electronic system 1100 can be, and/or can be a part of, Network 1 and Network 2 shown in FIG. 4. The electronic system 1100 may include various types of computer readable media and interfaces for various other types of computer readable media. The electronic system 1100 includes a bus 1110, one or more processing units 1114, a system memory 1104 (and/or buffer), a ROM 1112, a permanent storage device 1102, an input device interface 1106, an output device interface 1108, and one or more network interfaces 1116, or subsets and variations thereof.

The bus 1110 collectively represents all system, peripheral, and chipset buses that communicatively connect the numerous internal devices of the electronic system 1100. In one or more implementations, the bus 1110 communicatively connects the one or more processing units 1114 with the ROM 1112, the system memory 1104, and the permanent storage device 1102. From these various memory units, the one or more processing units 1114 retrieves instructions to execute and data to process in order to execute the processes of the subject disclosure. The one or more processing units 1114 can be a single processor or a multi-core processor in different implementations.

The ROM 1112 stores static data and instructions that are needed by the one or more processing units 1114 and other modules of the electronic system 1100. The permanent storage device 1102, on the other hand, may be a read-and-write memory device. The permanent storage device 1102 may be a non-volatile memory unit that stores instructions and data even when the electronic system 1100 is off. In one or more implementations, a mass-storage device (such as a magnetic or optical disk and its corresponding disk drive) may be used as the permanent storage device 1102.

In one or more implementations, a removable storage device (such as a flash drive, and its corresponding disk drive) may be used as the permanent storage device 1102. Like the permanent storage device 1102, the system memory 1104 may be a read-and-write memory device. However, unlike the permanent storage device 1102, the system memory 1104 may be a volatile read-and-write memory, such as random access memory. The system memory 1104 may store any of the instructions and data that one or more processing units 1114 may need at runtime. In one or more implementations, the processes of the subject disclosure are stored in the system memory 1104, the permanent storage device 1102, and/or the ROM 1112 (which are each implemented as a non-transitory computer-readable medium). From these various memory units, the one or more processing units 1114 retrieves instructions to execute and data to process in order to execute the processes of one or more implementations.

The bus 1110 also connects to the input device interface 1106 and output device interface 1108. The input device interface 1106 enables a user to communicate information and select commands to the electronic system 1100. Input devices that may be used with the input device interface 1106 may include, for example, alphanumeric keyboards and pointing devices (also called “cursor control devices”). The input device interface 1106 may enable, for example, the display of images generated by electronic system 1100. Output devices that may be used with the input device interface 1106 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

The bus 1110 also couples the electronic system 1100 to one or more networks and/or to one or more network nodes, such as Network 1, Network 2, and the end device 408, shown in FIG. 4, through the one or more network interfaces 1116. In this manner, the electronic system 1100 can be a part of a network of computers (such as a LAN, a wide area network (“WAN”), or an Intranet, or a network of networks, such as the Internet. Any or all components of the electronic system 1100 can be used in conjunction with the subject disclosure.

These functions described above can be implemented in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (also referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, and/or any other optical or magnetic media. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; e.g., feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; e.g., by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and may interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

As described above, one aspect of the present technology is the gathering and use of data available from specific and legitimate sources for reconnecting devices over a network. The present disclosure contemplates that in some instances, this gathered data may include personal information data that uniquely identifies or can be used to identify a specific person. Such personal information data can include audio data, voice data, demographic data, location-based data, online identifiers, telephone numbers, email addresses, home addresses, encryption information, data or records relating to a user's health or level of fitness (e.g., vital signs measurements, medication information, exercise information), date of birth, or any other personal information.

The present disclosure recognizes that the use of personal information data, in the present technology, can be used to the benefit of users. For example, the personal information data can be used for reconnecting devices over a network.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of reconnecting devices over a network, the present technology can be configured to allow users to select to “opt in” or “opt out” of participation in the collection and/or sharing of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level or at a scale that is insufficient for facial recognition), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

When an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
obtaining, over a mesh network, a first context identifier from an end device;
registering, based on the first context identifier and a first prefix mapped with the first context identifier, a first address for the end device;
updating from the first prefix to a second prefix, the second prefix being associated with the first context identifier; and
in response to a determination that the end device requested to re-register the first address based on the first prefix, providing an update request to the end device to update the first prefix to the second prefix.

2. The method of claim 1, wherein the providing the update request causes the end device to register a second address based on the second prefix.

3. The method of claim 2, subsequent to providing the update request, receiving, from the end device, an update response that the end device registered the second address.

4. The method of claim 2, further comprising transmitting data, via the second address, to the end device.

5. The method of claim 2, further comprising:
providing, to a controller via a network different from the mesh network, the second address;
receiving, from the controller over the network, a command to control the end device; and
providing the command to the end device.

6. The method of claim 5, wherein providing the command comprises providing, via the second address over the mesh network, the command to the end device.

7. The method of claim 1, wherein:
while updating from the first prefix to the second prefix, determining the end device is in an inactive state, and
providing, subsequent to the end device transitioning from the inactive state to an active state, the update request.

8. The method of claim 1, wherein updating from the first prefix to the second prefix comprises undergoing a reset based on a power outage.

9. The method of claim 1, wherein the update request causes the end device to remove a second context identifier.

10. A non-transitory computer-readable medium, comprising:
computer-readable instructions that, when executed by a processor, cause the processor to perform one or more operations comprising:
obtaining, via a first router over a mesh network, a first prefix and a first context identifier;
generating, based on the first prefix and the first context identifier, a first address;
connecting, over the mesh network and based in part on the first address, to the first router; and
in response to disconnecting with the first router over the mesh network, clearing the first context identifier and deregistering the first address.

11. The non-transitory computer-readable medium of claim 10, wherein the one or more operations further comprise subsequent to clearing the first context identifier and deregistering the first address:
obtaining, via the first router over the mesh network, a second prefix and the first context identifier;
generating, based on the second prefix and the first context identifier, a second address;
storing the second address; and
connecting, based on the second address, to the first router over the mesh network.

12. The non-transitory computer-readable medium of claim 10, wherein in response to disconnecting with the first router over the mesh network comprises a disconnecting, based on a reset to at least the first router or a second router.

13. The non-transitory computer-readable medium of claim 12, wherein the one or more operations further comprise subsequent to clearing the first context identifier and deregistering the first address:
obtain, from one of the first router and the second router, an update request to register a second prefix address and the first context identifier.

14. The non-transitory computer-readable medium of claim 13, further receiving an update response acknowledgement indicating the second prefix address and the first context identifier are registered.

15. The non-transitory computer-readable medium of claim 10, wherein clearing the first context identifier comprises removing the first context identifier from memory.

16. A system, comprising:
a memory; and
a processor configured to:
identify a first partition of one or more first devices connected over a mesh network;
identify a second partition of one or more second devices over the mesh network; and
in response to a determination the one or more second devices does not include a border router, merge the first partition and the second partition.

17. The system of claim 16, wherein in response to the first partition merged with the second partition, connect the one or more second devices to the first partition.

18. The system of claim 16, the processor is further configured to:
merge, in accordance with a set of rules, the first partition and the second partition, and
prioritize the determination over the set of rules.

19. The system of claim 16, the processor is further configured to:
in response to a strength indicator from a device of the one or more second devices being less than a threshold above a noise floor, merge the first partition and the second partition.

20. The system of claim 16, wherein:
the determination that the one or more second devices does not include the border router defines a first rule, and
the processor is further configured to determine the first rule is prioritized over the second rule prior to the merge.
